(19) United States
(12) Patent Application Publication
(10) Pub. No.: US 2006/0239469 A1
(43) Pub. Date: Oct. 26, 2006

(54) Story-telling doll

(76) Inventors: Assaf Gil, Givatayim (IL); Ilan Morad, Petach Tikva (IL); Eitan Morad, Petach Tikva (IL); Arie Litbak, Rehovot (IL); Yaniv Petel, Herzlia (IL)

Correspondence Address: Mark Friedman;Bill Polkinghorn, 9003 Florin Way, Upper Marlboro, MD, 20772, US

(21) Appl. No.: 10/560,166

(22) PCT Filed: Jun. 9, 2004
(86) PCT No.: PCT/IL04/00510

§ 371 Date: May 30, 2006

(51) Int. Cl. H04B 3/00

(52) U.S. Cl. 381/81

(57) ABSTRACT

A story-telling doll includes a doll body (10) which contains a processing system (12) including at least one digital processor, a programmable data storage device (14) and an audio output device (16). At least one user-operable switch (SW1, SW2, SW3) is manually operable by manipulation of at least one region (18, 20, 22) of body (10) to provide an input signal to processing system (12). A communications unit (24), also contained within body (10), is configured to operate under control of processing unit (12) in response to the input signal to: (a) initiate a data communications link via a general purpose communications network with a remote content provider source, (b) transmit to the remote content provider a request for download of at least one data file including audio content, and (c) receive the at least one data file including audio content from the remote content provider. Processor system (12) is further configured to save the at least one data file in storage device (14) and subsequently to play the audio content read from the at least one data file via audio output device (16).

### FIELD AND BACKGROUND OF THE INVENTION

The present invention relates to children's toys and, in particular, it concerns a doll for telling stories to children.

It is known to provide dolls with audio output capabilities for use in story-telling equipment for entertaining children. An example of such a system is U.S. Pat. No. 6,512,832 to Braun et al. where wireless speakers are covered by corresponding dolls making the dolls appear to speak parts corresponding to their roles in a story. In this case, the dolls are passive devices operated remotely by a base unit.

A number of other references relate to dolls which operate as computer peripheral devices to provide computer-controlled animation and audio output. Examples of such systems may be found in U.S. Pat. No. 4,846,693 to Baer and U.S. Pat. No. 5,746,602 to Kikinis. In both cases, the doll's function is directly controlled by the computer.

U.S. Pat. No. 5,873,765 to Rifkin et al. and U.S. Pat. No. 6,012,961 to Sharpe, III et al. describe story-telling dolls which are operable in a free-standing mode to play a story stored in memory within the doll. This renders the doll much more suitable for general purpose use by a child who can freely take the doll to play or into bed without maintaining connection to a computer.

The dolls of both Rifkin et al. and Shape, III et al. both allow updating of the audio content stored within the memory of the doll by docking with a computer. As a result, despite the advantages of the free-standing playback mode of operation, updating of the audio content of these devices is totally dependent upon an external computer. The required availability of a computer, and the need for some degree of computer literacy precludes operation of the device, by young children and non-computer-minded adults, or when traveling away from the computer.

There is therefore a need for a storytelling doll which would perform updating of re-programmable audio content without connection to an external computer.

### SUMMARY OF THE INVENTION

The present invention is a storytelling doll and a corresponding system for managing audio content update for such dolls.

According to the teachings of the present invention there is provided, a story-telling doll comprising: (a) a doll body; (b) a processing system including at least one digital processor, the processing system being contained within the body; (c) a programmable data storage device associated with the processing system and contained within the body; (d) an audio output device associated with the processing system and contained within the body; (e) at least one user-operable switch manually operable by manipulation of at least one region of the body, the at least one switch being operative to provide an input signal to the processing system; and (f) a communications unit associated with the processing system and contained within the body, the communications unit being configured to operate under control of the processing unit in response to the input signal to: (i) initiate a data communications link via a general purpose communications network with a remote content provider source, (ii) transmit to the remote content provider a request for download of at least one data file including audio content, and (iii) receive the at least one data file including audio content from the remote content provider, wherein the processor system is operative to save the at least one data file in the storage device and subsequently to play the audio content read from the at least one data file via the audio output device.

According to a further feature of the present invention, the communications unit includes a modem configured for initiating a data connection across a telephone network.

According to a further feature of the present invention, the modem is a PSTN modem configured for initiating a data connection across a PSTN telephone network. Alternatively, the modem is configured for initiating a data connection across a cellular telephone network.

According to a further feature of the present invention, the doll further includes a socket associated with the modem and configured for wired connection to the telephone network.

According to a further feature of the present invention, the processing system is further configured to: (a) receive via the communications unit information indicative of at least two options relating to data files available for download from the remote content provider; (b) generate via the audio output device an audio prompt indicative of the at least two options; (c) receive via the at least one switch a user response indicative of a selected option; and (d) transmit to the remote content provider a response indicative of the selected option.

According to a further feature of the present invention, the at least one user-operable switch includes a switch manually operable by manipulation of a limb of the doll body.

According to a further feature of the present invention, the at least one user-operable switch includes a switch manually operable by manipulation of a head of the doll body.

According to a further feature of the present invention, the at least one user-operable switch includes a switch manually operable by depressing a button associated with an external surface of the doll body.

According to a further feature of the present invention, there is also provided: (a) a rechargeable battery deployed within the doll body for powering at least the processor system, the rechargeable battery being electrically connected to a connector; and (b) a charging unit deployed separate from the doll body and configured for mating with the connector so as to charge the rechargeable battery.

According to a further feature of the present invention, the connector further includes communication connections associated with the communications unit.

There is also provided according to the teachings of the present invention, a story-telling doll system for providing repeatedly updated audio content for playing by a plurality of dolls, the system comprising: (a) a plurality of the aforementioned story-telling dolls, each configured to transmit an identification code; and (b) a remote content provider system including: (i) a communications subsystem associated with the general purpose communications network; (ii) a database subsystem including a registry of doll identification codes and associated content definitions; and (iii) a content management subsystem associated with the communications subsystem and the database subsystem, the content management subsystem storing data files of a plurality of content types, the content management subsystem being responsive to the identification code to: (A) retrieve from the database subsystem a content definition associated with each received identification code, and (B) make available for download at least one data file having a content type corresponding to the retrieved content definition.

According to a further feature of the present invention, the plurality of content types includes a first age-range category and a second age-range category. Alternatively, or additionally, the plurality of content types includes a first language category and a second language category. Alternatively, or additionally, the plurality of content types includes at least one special-interest group.

### BRIEF DESCRIPTION OF THE DRAWINGS

The invention is herein described, by way of example only, with reference to the accompanying drawings, wherein:

FIG. 1 is a schematic representation of a doll, constructed and operative according to the teachings of the present invention;

FIG. 2 is a flow diagram illustrating a preferred sequence of operations of the doll of FIG. 1 during updating of the stored audio content;

FIG. 3 is a flow diagram illustrating a preferred sequence of operations of the doll of FIG. 1 during playback;

FIG. 4 is a block diagram representing the main subsystems of a remote content-providing system, constructed and operative according to the teachings of the present invention, for use with a number of the dolls of FIG. 1; and

FIG. 5 is a flow diagram illustrating a preferred sequence of operations performed by the remote content-providing system of FIG. 4.

### DESCRIPTION OF THE PREFERRED EMBODIMENTS

The present invention is a story-telling doll and a corresponding system for managing audio content update for such dolls.

The principles and operation of dolls and corresponding systems according to the present invention may be better understood with reference to the drawings and the accompanying description.

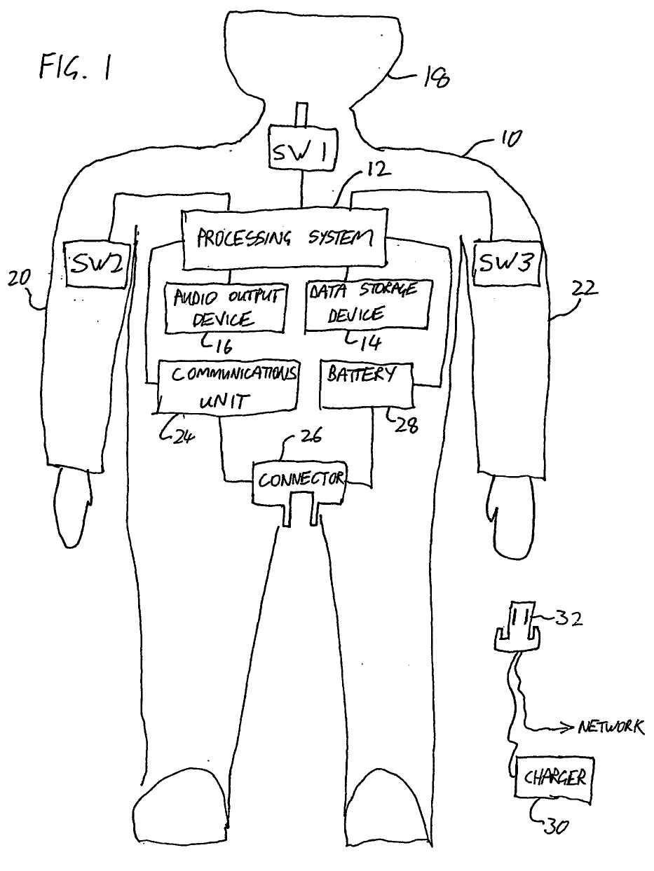

Referring now to the drawings, FIG. 1 shows a preferred embodiment of a story-telling doll constructed and operative according to the teachings of the present invention. Generally speaking, the storytelling doll includes a doll body 10 which contains a processing system 12 including at least one digital processor, a programmable data storage device 14 associated with processing system 12, and an audio output device 16 associated with processing system 12. At least one user-operable switch SW1, SW2, SW3 is manually operable by manipulation of at least one region 18, 20, 22 of body 10 to provide an input signal to processing system 12. A communications unit 24, also contained within body 10, is configured to operate under control of processing unit 12 in response to the input signal to: (a) initiate a data communications link via a general purpose communications network with a remote content provider source, (b) transmit to the remote content provider a request for download of at least one data file including audio content, and (c) receive the at least one data file including audio content from the remote content provider. Processor system 12 is further configured to save the at least one data file in storage device 14 and subsequently to play the audio content read from the at least one data file via audio output device 16.

At this stage, it will already be apparent that the story-telling doll of the present invention offers profound advantages over the dolls of the Rifkin et al. and Shape, III et al. devices discussed above. Specifically, by including communications unit 24 driven by processing system 12, the doll is rendered independent of local computer connections, thereby allowing updating of audio content without requiring computer hardware or know-how. This and other advantages of the present invention will become clearer from the subsequent description.

Before addressing the structure and operation of the present invention in more detail, it will first be helpful to define certain terminology as used herein in the description and claims. Firstly, it should be noted that the term “doll” is used herein in a broad sense to refer generically to any type of doll, teddy bear, figurine, soft-toy or other form of toy which is suited to a story-telling role.

Reference is made herein to a data communications link over a general purpose communications network. The phrase “general purpose communications network” is used herein to refer to any wide-area communications network which is used for voice or data communications between remote locations and which is not wholly dedicated to transmission of the data of the present invention. The network may employ analogue or digital transmission, and may be based on any combination of conductive wire, optic fiber, radio frequency electromagnetic radiation and any other communications connections. Preferred examples of communications networks with which the present invention may be used include, but are not limited to, cellular telephone networks and public switching telephone networks (“PSTN”) upon which conventional telephone systems are typically based.

Reference is also made herein to a “data file including audio content.” This phrase is used herein to refer to any data file which is to be used by a device as a basis for generating audio output. Thus, examples of a “data file including audio content” according to the present invention include, but are not limited to: audio formats such as WAV or MP3 format; text-containing files to be processed by a speech synthesizer module within processing system 12; and instruction files including lists of instructions for a preprogrammed sound generator module.

Turning now to the features of the present invention in more detail, communications unit 24 may be substantially any type of communications unit configured for initiating a data communications link via a general purpose communications network. In a particularly preferred example, communications unit 24 includes a modem configured for initiating a data connection across a telephone network. The doll preferably further includes a socket 26 associated with the modem and configured for wired connection to the telephone network.

In a first implementation, the modem is a PSTN modem configured for initiating a data connection across a PSTN telephone network. In this case, the only connection typically required for communications to the remote content provider source is insertion of a conventional telephone jack into socket 26.

In a second implementation, the modem is a cellular modem configured for initiating a data connection across a cellular telephone network. In this case, the modem may advantageously be configured to interface via a cable or wirelessly with a conventional cellular telephone (not shown) in order to avoid including within the doll itself high-power RF radiation-generating components, which may be considered a safety-hazard or a health-hazard to children.

Electrical power to processing system 12 and the various components of the doll of the present invention is preferably provided, directly or indirectly, by a rechargeable battery 28 deployed within doll body 10. Rechargeable battery 28 is preferably electrically connected to an externally accessible connector. A charging unit 30, deployed separate from doll body 10, is configured for mating with the connector so as to charge the rechargeable battery. In the example shown here, connection is via a plug 32 linked to charging unit 30 by wires, although an alternative implementation where plug 32 is integrally formed with charging unit 30 in the form of a chair or other docking configuration may be preferred.

In the particularly preferred example illustrated here, connector 26 includes connections for both the rechargeable battery and the communications unit, thereby facilitating completion of both charging and communications connections by insertion of a single plug 32.

It is a particularly preferred feature of most preferred implementations of the present invention that actuation of the functions of the doll, including updating of the audio content, is extremely simple and requires no computer know-how. To this end, the number of user operated switches is preferably small, and typically no more than three. Most preferably, the audio content update process is initiated by a single switch operation. During the download process, any user selections are preferably performed by single switch operations in response to straightforward audio cues. For example: “To get ‘Lord of the Rings’ lift my red arm; to get ‘Winnie-The-Pooh and the Blustery Day’ lift my blue arm.” The user interface thus provides completely intuitive initiation and control of the download process without requiring any computer skills, and can even be managed by relatively young children. When the download is complete, similar single switch operations are preferably effective to initiate playback of the corresponding story.

Operation of the switches is performed by manipulation of at least a region of doll body 10. This “region” may be a body portion of the doll or may be an identifiable input device such as a button deployed on a surface of the doll. In the particularly preferred implementation illustrated here, a first switch SW1 is implemented as a switch manually operable by manipulation (nodding or depression) of a head of the doll body, while two further switches SW2 and SW3 are manually operable by manipulation of corresponding limbs (in this case, arms) of doll body 10. Clearly, the number of switches and their deployment can be varied to suit other desired applications.

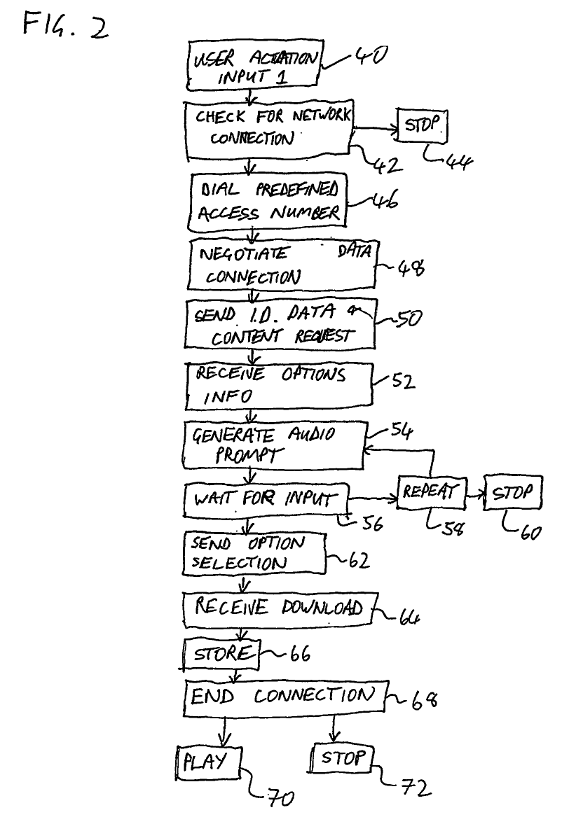

Turning now to FIG. 2, this shows in more detail a preferred sequence of operation of the doll of FIG. 1 during the audio content updating process. First, the update process is initiated in response to a user actuation of a predefined type, for example by nodding the doll's head to actuate switch SW1 (step 40). Then, at step 42, processor 12 preferably actuates communications unit 24 to check for the presence of the network connection, for example, by sensing a dial tone on a PSTN telephone network. If the required connection is not available, the update process is typically aborted (step 44), most generating a verbal audio prompt such as: “I didn't manage to dial out at the moment. Please check the phone connection is plugged-in and try again.”

Assuming the network is found to be available, communications unit 24 is then made to dial a predefined access number (step 46) to contact a remote content provider service, and to negotiate a data connection (step 48). Communications unit 24 then sends a request for content download (step 50), preferably associated with identification data and/or a security code which serve to check authorization of the doll to access the downloadable content and may be used in automatic content filtering, as will be described further below. Clearly, step 50 may be incorporated as part of an interactive login procedure as part of step 48 if preferred.

In most preferred implementations, the update process includes options to choose between two or more audio content files for download. In this case, the doll receives at step 52 information relating to the available options, typically in the form of a title of each available option or as menu options prior to choosing the actual content. In each case, the information is then preferably used to generate an audio prompt (step 54) indicating to the user what options are available and what input switches should be used to indicate the user's choice. In order to facilitate this procedure, the title information or other option information may be provided to the doll in the form of audio clips ready for direct use as prompts. The doll then waits for the required user input (step 56). If no input is received within a predefined period, the selection process is preferably repeated a predefined number of times (i.e., returning via step 58 to step 54) and then is finally aborted at step 60 if no selection is received. Alternatively, one of the available options may be designated as the default option and may be selected automatically if no input is received. After user selection of a given option, or selection by default, a response indicative of the selected option is sent by communications unit 24 back to the remote content provider system at step 62.

After option selection or, in a simple implementation where no options are offered, directly after step 50, communications unit 24 receives download of the desired data file (step 64) which processing system 12 stores in the data storage device 14 (step 66). On completion of the download, the doll is typically configured to end the data connection (step 68), preferably in conjunction with an audio prompt informing the user that the download was successful and that the phone line or other network connection can be disconnected. The doll may then be configured either to immediately initiate playback of the downloaded content (step 70) or to terminate operation until playback is initiated by a separate user actuation input (step 72).

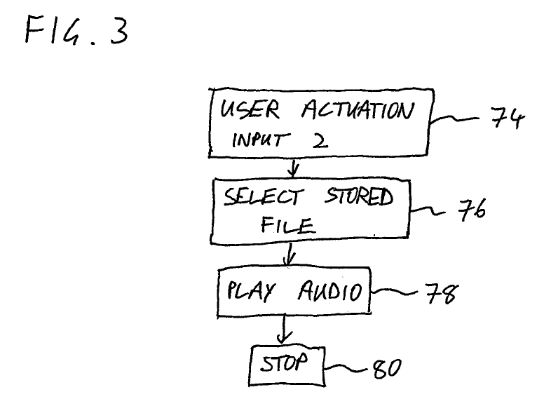

Turning now to FIG. 3, this shows a preferred implementation of the playback process of the doll of the present invention. Specifically, playback is preferably initiated by operation of a switch other than that used to initiate content download (step 74). In the example of FIG. 1, each of SW2 and SW3 may be operable to initiate playback of a corresponding selected story from data storage device 14. Processing system 12 then selects the requested stored file (step 76) and plays the audio content via audio output device 16 (step 78). On completion of the content, the device preferably deactivates until the next playback or content update actuation input is received (step 80).

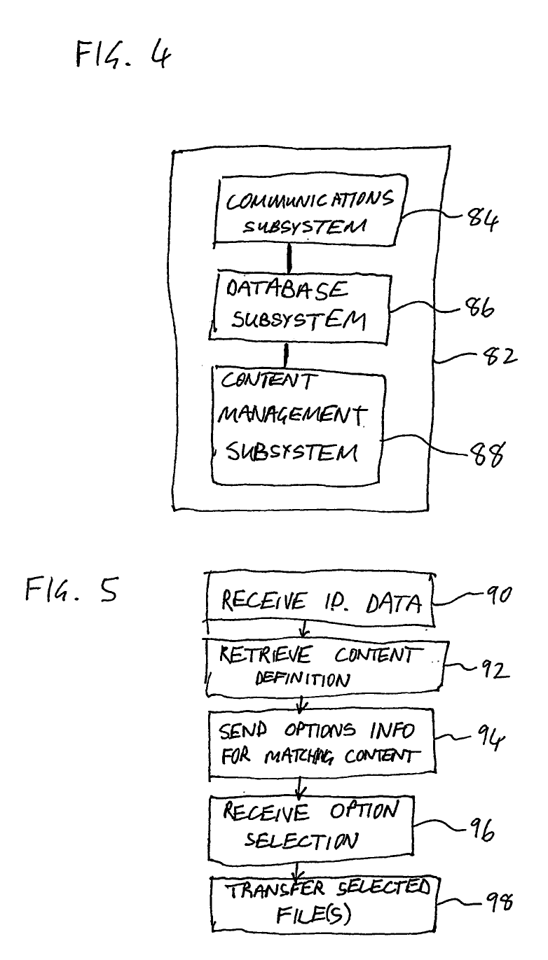

Turning now to FIGS. 4 and 5, it will be appreciated that the story-telling doll described thus far operates as part of a system together with a remote content provider system. The remote content provider system preferably serves many such dolls and provides each with appropriately filtered content according to various settings determined by the user and/or the content supplier. By way of example, a first doll may be intended for use by a three-year-old child while another doll is to be used by an eight-year-old child. In each case, suitable content must be made available to maintain the interest of the child. Similarly, the content may be customized to offer various different spoken languages, or to cater to the needs of different ethnic, social or religious groups, or to various special-interest groups.

A preferred implementation of a remote content provider system 82 is illustrated schematically in FIG. 4. Remote content provider system 82 here includes a communications subsystem 84 associated with the general purpose communications network, a database subsystem 86 including a registry of doll identification codes and associated content definitions, and a content management subsystem 88 associated with the communications subsystem and the database subsystem. Content management subsystem 88 stores data files of a plurality of content types.

The operation of remote content provider system 82 is illustrated in

FIG. 5. Specifically, content management subsystem 88 receives a doll identification code via communications subsystem 84 (step 90) and retrieves from database subsystem 86 a corresponding content definition (step 92). Content management subsystem 88 then filters the available content according to the retrieved content definition and selectively makes only matching content available for download. In the case that more than one matching data file is available, the aforementioned options selection procedure is performed by sending options info at step 94 and receiving option selection at step 96. The selected file or files are then transferred to the corresponding story-telling doll at step 98.

Most preferably, the content definitions for each doll may be updated by the user to reflect changing needs, for example, as a child gets older and his or her interests change. Updating of the content definitions may conveniently be provided by a manned or automatic telephone answering service. A profile update function may also be provided via alternative interfaces such as, for example, via an internet web-page interface.

In an alternative implementation, part or all of the content definitions for each doll may be stored in the doll itself. In this case, the doll would transmit content definitions to the remote content provider system as part of the content request, effectively making a detailed request for the type of content it should receive. This option may partially, or wholly, circumvent the database subsystem 86 since the content definitions are provided directly by the doll and do not need to be retrieved from a separate database. In this case, updating of the content definitions may be performed remotely from the remote content provider system.

Typically, the content offered by the remote content provider system is changed periodically and frequently, for example daily, such that the story-telling doll can provide one or more new story each day, thereby maintaining the child's interest.

It will be appreciated that the above descriptions are intended only to serve as examples, and that many other embodiments are possible within the scope of the present invention as defined in the appended claims.

1. A story-telling doll comprising:
(a) a doll body;
(b) a processing system including at least one digital processor, said processing system being contained within said body;
(c) a programmable data storage device associated with said processing system and contained within said body;
(d) an audio output device associated with said processing system and contained within said body;
(e) at least one user-operable switch manually operable by manipulation of at least one region of said body, said at least one switch being operative to provide an input signal to said processing system; and
(f) a communications unit associated with said processing system and contained within said body, said communications unit being configured to operate under control of said processing unit in response to said input signal to:
(i) initiate a data communications link via a general purpose communications network with a remote content provider source,
(ii) transmit to the remote content provider a request for download of at least one data file including audio content, and
(iii) receive the at least one data file including audio content from the remote content provider,
wherein said processor system is operative to save the at least one data file in said storage device and subsequently to play said audio content read from said at least one data file via said audio output device.

2. The story-telling doll of claim 1, wherein said communications unit includes a modem configured for initiating a data connection across a telephone network.

3. The story-telling doll of claim 2, wherein said modem is a PSTN modem configured for initiating a data connection across a PSTN telephone network.

4. The story-telling doll of claim 2, wherein said modem is configured for initiating a data connection across a cellular telephone network.

5. The story-telling doll of claim 2, wherein said doll further includes a socket associated with said modem and configured for wired connection to the telephone network.

6. The story-telling doll of claim 1, wherein said processing system is further configured to:
(a) receive via said communications unit information indicative of at least two options relating to data files available for download from the remote content provider;
(b) generate via said audio output device an audio prompt indicative of said at least two options;
(c) receive via said at least one switch a user response indicative of a selected option; and
(d) transmit to the remote content provider a response indicative of the selected option.

7. (canceled)

8. (canceled)

9. The story-telling doll of claim 1, wherein said at least one user-operable switch includes a switch manually operable by depressing a button associated with an external surface of the doll body.

10. The story-telling doll of claim 1, further comprising:
(a) a rechargeable battery deployed within said doll body for powering at least said processor system, said rechargeable battery being electrically connected to a connector; and
(b) a charging unit deployed separate from said doll body and configured for mating with said connector so as to charge said rechargeable battery.

11. The story-telling doll of claim 10, wherein said connector further includes communication connections associated with said communications unit.

12. A story-telling doll system for providing repeatedly updated audio content for playing by a plurality of dolls, the system comprising:
(a) a plurality of story-telling dolls according to claim 0, each of said dolls being configured to transmit an identification code; and
(b) a remote content provider system including:
(i) a communications subsystem associated with the general purpose communications network;
(ii) a database subsystem including a registry of doll identification codes and associated content definitions; and
(iii) a content management subsystem associated with said communications subsystem and said database subsystem, said content management subsystem storing data files of a plurality of content types, said content management subsystem being responsive to said identification code to:
(A) retrieve from said database subsystem a content definition associated with each received identification code, and
(B) make available for download at least one data file having a content type corresponding to the retrieved content definition.

13. The system of claim 12, wherein said plurality of content types includes a first age-range category and a second age-range category.

14. The system of claim 12, wherein said plurality of content types includes a first language category and a second language category.

15. The system of claim 12, wherein said plurality of content types includes at least one special-interest group.

16. A story-telling doll comprising:
(a) a doll body;
(b) a processing system including at least one digital processor, said processing system being contained within said body;
(c) a programmable data storage device associated with said processing system and contained within said body;
(d) an audio output device associated with said processing system and contained within said body;
(e) at least one user-operable switch manually operable by manipulation of at least one region of said body, said at least one switch being operative to provide an input signal to said processing system; and
(f) a communications unit associated with said processing system and contained within said body, said communications unit being configured to operate under control of said processing unit to:
(i) establish a data communications link with a cellular telephone, and
(ii) receive from the cellular telephone at least one data file including audio content,
wherein said processor system is operative to save the at least one data file in said storage device and subsequently to play said audio content read from said at least one data file via said audio output device.

17. The story-telling doll of claim 16, wherein said doll further includes a socket configured for wired connection to the cellular telephone.

18. The story-telling doll of claim 16, wherein said communications unit is configured to interface wirelessly with the cellular telephone.

19. A combination of the story-telling doll of claim 16 and a cellular telephone in data communication with the doll, said cellular telephone being in communication with a cellular communications network for downloading said at least one data file including audio content from a remote content provider source.

20. The story-telling doll of claim 16, wherein said at least one user-operable switch includes a switch manually operable by depressing a button associated with an external surface of the doll body.

21. The story-telling doll of claim 16, further comprising:
(a) a rechargeable battery deployed within said doll body for powering at least said processor system, said rechargeable battery being electrically connected to a connector; and
(b) a charging unit deployed separate from said doll body and configured for mating with said connector so as to charge said rechargeable battery.

22. The story-telling doll of claim 21, wherein said connector further includes communication connections associated with said communications unit.
